(19) United States
(12) Patent Application Publication
(10) Pub. No.: US 2007/0206117 A1
(43) Pub. Date: Sep. 6, 2007

(54) MOTION AND APPARATUS FOR SPATIO-TEMPORAL DEINTERLACING AIDED BY MOTION COMPENSATION FOR FIELD-BASED VIDEO

(75) Inventors: Tao Tian, San Diego, CA (US); Fang Shi, San Diego, CA (US); Vijayalakshmi R. Raveendran, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/536,894

(22) Filed: Sep. 29, 2006

Related U.S. Application Data
(60) Provisional application No. 60/727,643, filed on Oct. 17, 2005.
(60) Provisional application No. 60/789,048, filed on Apr. 3, 2006.

(51) Int. Cl. H04N 7/01

(52) U.S. Cl. 348/452

(57) ABSTRACT

The invention comprises devices and methods for processing multimedia data to generate progressive frame data from interlaced frame data. In one aspect, a method of processing multimedia data includes generating spatio-temporal information for a selected frame of interlaced multimedia data, generating motion information for the selected frame, and deinterlacing fields of the selected frame based on the spatio-temporal information and the motion information to form a progressive frame associated with the selected frame. In another aspect an apparatus for processing multimedia data can include a spatial filter module configured to generate spatio-temporal information of a selected frame of interlaced multimedia data, a motion estimator configured to generate motion information for the selected frame, and a deinterlacer configured to deinterlace fields of the selected frame and form a progressive frame corresponding to the selected frame based on the spatio-temporal information and the motion information.

### CLAIM OF PRIORITY UNDER 35 U.S.C. §119

The Application for Patent claims priority to (1) Provisional Application No. 60/727,643 entitled “METHOD AND APPARATUS FOR SPATIO-TEMPORAL DEINTERLACING AIDED BY MOTION COMPENSATION FOR FIELD-BASED VIDEO” filed Oct. 17, 2005, and (2) Provisional Application No. 60/789,048 entitled “SPATIO-TEMPORAL DEINTERLACING AIDED BY MOTION COMPENSATION FOR FIELD-BASED MULTIMEDIA DATA” filed Apr. 3, 2006. Both provisional patent applications are assigned to the assignee hereof and hereby expressly incorporated by reference herein.

### BACKGROUND

1. Field

The invention generally is directed to multimedia data processing, and more particularly, to deinterlacing multimedia data based on spatio-temporal and motion compensation processing.

2. Background

Deinterlacing refers to a process of converting interlaced video (a sequence of fields) into non-interlaced progressive frames (a sequence of frames). Deinterlacing processing of multimedia data (sometimes referred to herein simply as “deinterlacing”) produces at least some image degradation because it requires interpolation between corresponding first and second interlaced fields and/or temporally adjacent interlaced fields to generate the “missing” data may be needed to produce a progressive frame. Typically, deinterlacing processes use a variety of linear interpolation techniques and are designed to be relatively computationally simple to achieve fast processing speeds.

The increasing demand for transmitting interlaced multimedia data to progressive frame displaying devices (e.g., cell phones, computers, PDA's) has also increased the importance of deinterlacing. One challenge for deinterlacing is that field-based video signals usually do not fulfill the demands of the sampling theorem. The theorem states that exact reconstruction of a continuous-time baseband signal from its samples is possible if the signal is bandlimited and the sampling frequency is greater than twice the signal bandwidth. If the sampling condition is not satisfied, then frequencies will overlap and the resulting distortion is called aliasing. In some TV broadcasting systems prefiltering prior to sampling, that could remove aliasing conditions, is missing. Typical deinterlacing techniques, including BOB (vertical INTRA-frame interpolation), weave (temporal INTER-frame interpolation), and linear VT (vertical and temporal) filters also do not overcome aliasing effects. Spatially these linear filters treat image edges the same way as smooth regions. Accordingly, resulting images suffer from blurred edges. Temporally these linear filters do not utilize motion information, and resulting images suffer from a high alias level due to unsmooth transition between original fields and recovered fields. Despite the poor performance of linear filters, they are still widely used because of their low computational complexity. Thus, Applicant submits that there is a need for improved deinterlacing methods and systems.

### SUMMARY

Each of the inventive apparatuses and methods described herein has several aspects, no single one of which is solely responsible for its desirable attributes. Without limiting the scope of this invention, its more prominent features will now be discussed briefly. After considering this discussion, and particularly after reading the section entitled “Detailed Description” one will understand how the features of this invention provides improvements for multimedia data processing apparatuses and methods.

In one aspect, a method of processing multimedia data includes generating spatio-temporal information for a selected frame of interlaced multimedia data, generating motion compensation information for the selected frame, and deinterlacing fields of the selected frame based on the spatio-temporal information and the motion compensation information to form a progressive frame associated with the selected frame. Generating spatio-temporal information can include processing the interlaced multimedia data using a weighted median filter and generating a spatio-temporal provisional deinterlaced frame. Deinterlacing fields of the selected frame further can include combining spatio-temporal provisional deinterlaced frame and motion compensated provisional deinterlaced frame to form a progressive frame. Motion vector candidates (also referred to herein as “motion estimators”) can be used to generate the motion compensation information. The motion compensation information can be bi-directional motion information. In some aspects, motion vector candidates are received and used to generate the motion compensation information. In certain aspects, motion vector candidates for blocks in a frame are determined from motion vector candidates of neighboring blocks. Generating spatio-temporal information can include generating at least one motion intensity map. In certain aspects, the motion intensity map categorizes three or more different motion levels. The motion intensity map can be used to classify regions of the selected frame into different motion levels. A provisional deinterlaced frame can be generated based on the motion intensity map, where various criteria of Wmed filtering can be used to generate the provisional deinterlaced frame based on the motion intensity map. In some aspects, a denoising filter, for example, a wavelet shrinkage filter or a Weiner filter, is used to remove noise from the provisional frame.

In another aspect, an apparatus for processing multimedia data includes a filter module configured to generate spatio-temporal information of a selected frame of interlaced multimedia data, a motion estimator configured to generate bi-directional motion information for the selected frame, and a combiner configured to form a progressive frame corresponding to the selected frame using the spatio-temporal information and the motion information. The spatio-temporal information can include a spatio-temporal provisional deinterlaced frame, the motion information can include a motion compensated provisional deinterlaced frame, and the combiner is configured to form a progressive frame by combining the spatio-temporal provisional deinterlaced frame and the motion compensated provisional deinterlaced frame.

In another aspect, an apparatus for processing multimedia data includes means for generating spatio-temporal information for a selected frame of interlaced multimedia data, means for generating motion information for the selected frame, and means for deinterlacing fields of the selected frame based on the spatio-temporal information and the motion information to form a progressive frame associated with the selected frame. The deinterlacing means can include means for combining the spatio-temporal provisional deinterlaced frame and the motion compensated provisional deinterlaced frame to form the progressive frame. More generally, the means for combining can be configured to form the progressive frame by combining spatial temporal information and motion information. The generating spatio-temporal information means can be configured to generate a motion intensity map of the selected frame and to use the motion intensity map to generate a spatio-temporal provisional deinterlaced frame. In some aspects, the generating spatio-temporal information means is configured to generate at least one motion intensity map, and generate a provisional deinterlaced frame based on the motion intensity map.

In another aspect, a machine readable medium comprising instructions that upon execution cause a machine to generate spatio-temporal information for a selected frame of interlaced multimedia data, generate bi-directional motion information for the selected frame, and deinterlace fields of the frame based on the spatio-temporal information and the motion information to form a progressive frame corresponding to the selected frame. As disclosed herein, a “machine readable medium” may represent one or more devices for storing data, including read only memory (ROM), random access memory (RAM), magnetic disk storage mediums, optical storage mediums, flash memory devices and/or other machine readable mediums for storing information. The term “machine readable medium” includes, but is not limited to portable or fixed storage devices, optical storage devices, wireless channels and various other mediums capable of storing, containing or carrying instruction(s) and/or data.

In another aspect, a processor for processing multimedia data, said processor includes a configuration to generate spatio-temporal information of a selected frame of interlaced multimedia data, generate motion information for the selected frame, and deinterlace fields of the selected frame to form a progressive frame associated with the selected frame based on the spatio-temporal information and the motion information.

### BRIEF DESCRIPTION OF THE DRAWINGS

FIG. 1 is a block diagram of a communications system for delivering streaming multimedia;

FIG. 2 is a block diagram of certain components of a communication system for delivering streaming multimedia;

FIG. 3A is a block diagram illustrating a deinterlacer device;

FIG. 3B is a block diagram illustrating another deinterlacer device;

FIG. 3C is a block diagram illustrating another deinterlacing apparatus;

FIG. 4 is drawing of a subsampling pattern of an interlaced picture;

FIG. 5 is a block diagram illustrating a deinterlacer device that uses Wmed filtering motion estimation to generate a deinterlaced frame;

FIG. 6 illustrates one aspect of an aperture for determining static areas of multimedia data;

FIG. 7 is a diagram illustrating one aspect of an aperture for determining slow-motion areas of multimedia data;

FIG. 8 is a diagram illustrating an aspect of motion estimation;

FIG. 9 illustrates two motion vector maps used in determining motion compensation;

FIG. 10 is a flow diagram illustrating a method of deinterlacing multimedia data;

FIG. 11 is a flow diagram illustrating a method of generating a deinterlaced frame using spatio-temporal information;

FIG. 12 is a flow diagram illustrating a method of performing motion compensation for deinterlacing;

FIG. 13 is an image illustrating an original selected “soccer” frame;

FIG. 14 is an image illustrating an interlaced frame of the image shown in FIG. 13;

FIG. 15 is an image illustrating a deinterlaced Wmed frame of the original soccer frame shown in FIG. 13; and

FIG. 16 is an image illustrating a deinterlaced frame resulting from combining the Wmed frame of FIG. 15 with motion compensation information.

### DETAILED DESCRIPTION

In the following description, specific details are given to provide a thorough understanding of the described aspects. However, it will be understood by one of ordinary skill in the art that the aspects may be practiced without these specific detail. For example, circuits may be shown in block diagrams in order not to obscure the aspects in unnecessary detail. In other instances, well-known circuits, structures and techniques may be shown in detail in order not to obscure the aspects.

Described herein are certain deinterlacing inventive aspects for systems and methods that that can be used, solely or in combination, to improve the performance of deinterlacing. Such aspects can include deinterlacing a selected frame using spatio-temporal filtering to determine a first provisional deinterlaced frame, using bi-directional motion estimation and motion compensation to determine a second provisional deinterlaced frame from the selected frame, and then combining the first and second provisional frames to form a final progressive frame. The spatio-temporal filtering can use a weighted median filter (“Wmed”) filter that can include a horizontal edge detector that prevents blurring horizontal or near horizontal edges. Spatio-temporal filtering of previous and subsequent neighboring fields to a “current” field produces an intensity motion-level map that categorizes portions of a selected frame into different motion levels, for example, static, slow-motion, and fast motion.

In some aspects, the intensity map is produced by Wmed filtering using a filtering aperture that includes pixels from five neighboring fields (two previous fields, the current field, and two next fields). The Wmed filtering can determine forward, backward, and bidirectional static area detection which can effectively handle scene changes and objects appearing and disappearing. In various aspects, a Wmed filter can be utilized across one or more fields of the same parity in an inter-field filtering mode, and switched to an intra-field filtering mode by tweaking threshold criteria. In some aspects, motion estimation and compensation uses luma (intensity or brightness of the pixels) and chroma data (color information of the pixels) to improve deinterlacing regions of the selected frame where the brightness level is almost uniform but the color differs. A denoising filter can be used to increase the accuracy of motion estimation. The denoising filter can be applied to Wmed provisional deinterlaced frames to remove alias artifacts generated by Wmed filtering. The deinterlacing methods and systems described herein produce good deinterlacing results and have a relatively low computational complexity that allow fast running deinterlacing implementations, making such implementations suitable for a wide variety of deinterlacing applications, including systems that are used to provide data to cell phones, computers and other types of electronic or communication devices utilizing a display.

References herein to “one aspect,” “an aspect,” some aspects,” or “certain aspects” mean that one or more of a particular feature, structure, or characteristic described in connection with the aspect can be included in at least one aspect. The appearances of such phrases in various places in the specification are not necessarily all referring to the same aspect, nor are separate or alternative aspects mutually exclusive of other aspects. Moreover, various features are described which may be exhibited by some aspects and not by others. Similarly, various requirements are described which may be requirements for some aspects but not other aspects.

“Deinterlacer” as used herein is a broad term that can be used to describe a deinterlacing system, device, or process (including for example, software, firmware, or hardware configured to perform a process) that processes, in whole or in significant part, interlaced multimedia data to form progressive multimedia data.

“Multimedia data” as used herein is a broad term that includes video data (which can include audio data), audio data, or both video data and audio data. “Video data” or “video” as used herein as a broad term, referring to sequences of images containing text or image information and/or audio data, and can be used to refer to multimedia data or the terms may be used interchangeably, unless otherwise specified.

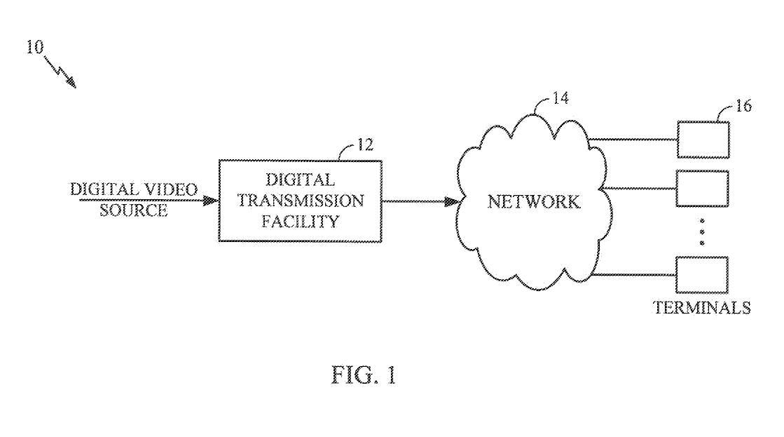

FIG. 1 is a block diagram of a communications system 10 for delivering streaming or other types of multimedia. This technique finds application in the transmission of digital compressed video to a multiplicity of terminals as shown in FIG. 1. A digital video source can be, for example, a digital cable feed or an analog high signal/ratio source that is digitized. The video source is processed in the transmission facility 12 and modulated onto a carrier for transmission through a network 14 to terminals 16. The network 14 can be any type of network, wired or wireless, suitable for the transmission of data. For example, the network can be a cell phone network, a local area or a wide area network (wired or wireless), or the Internet. The terminals 16 can be any type of communication device including, but not limited to, cell phones, PDA's, and personal computers.

Broadcast video that is conventionally generated—in video cameras, broadcast studios etc.—conforms in the United States to the NTSC standard. A common way to compress video is to interlace it. In interlaced data each frame is made up of one of two fields. One field consists of the odd lines of the frame, the other, the even lines. While the frames are generated at approximately 30 frames/sec, the fields are records of the television camera's image that are 1/60 sec apart. Each frame of an interlaced video signal shows every other horizontal line of the image. As the frames are projected on the screen, the video signal alternates between showing even and odd lines. When this is done fast enough, e.g., around 60 frames per second, the video image looks smooth to the human eye.

Interlacing has been used for decades in analog television broadcasts that are based on the NTSC (U.S.) and PAL (Europe) formats. Because only half the image is sent with each frame, interlaced video uses roughly half the bandwidth than it would sending the entire picture. The eventual display format of the video internal to the terminals 16 is not necessarily NTSC compatible and cannot readily display interlaced data. Instead, modern pixel-based displays (e.g., LCD, DLP, LCOS, plasma, etc.) are progressive scan and require progressively scanned video sources (whereas many older video devices use the older interlaced scan technology). Examples of some commonly used deinterlacing algorithms are described in “Scan rate up-conversion using adaptive weighted median filtering,” P. Haavisto, J. Juhola, and Y. Neuvo, Signal Processing of HDTV II, pp. 703-710, 1990, and “Deinterlacing of HDTV Images for Multimedia Applications,” R. Simonetti, S. Carrato, G. Ramponi, and A. Polo Filisan, in Signal Processing of HDTV IV, pp. 765-772, 1993.

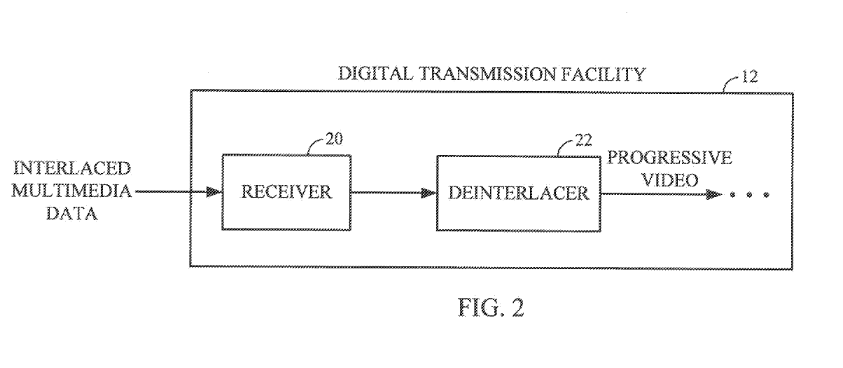

FIG. 2 illustrates certain components of a digital transmission facility 12 that is used to deinterlace multimedia data. The transmission facility 12 includes a receiver 20 in communication with a source of interlaced multimedia data. The source can be external, as shown, or it can be from a source internal to the transmission facility 12. The receiver 20 can be configured to receive the interlaced multimedia data in a transmission format and transform it into a format that is readily usable for further processing. The receiver 20 provides interlaced multimedia data to a deinterlacer 22 which interpolates the interlaced data and generates progressive video frames. The aspects of a deinterlacer and deinterlacing methods are described herein with reference to various components, modules and/or steps that are used to deinterlace multimedia data.

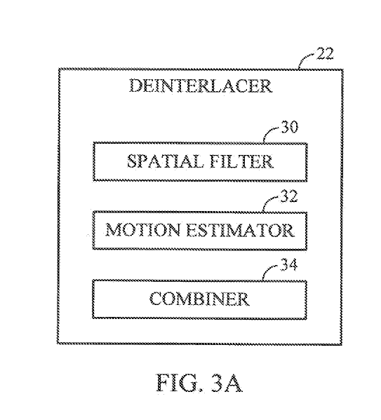

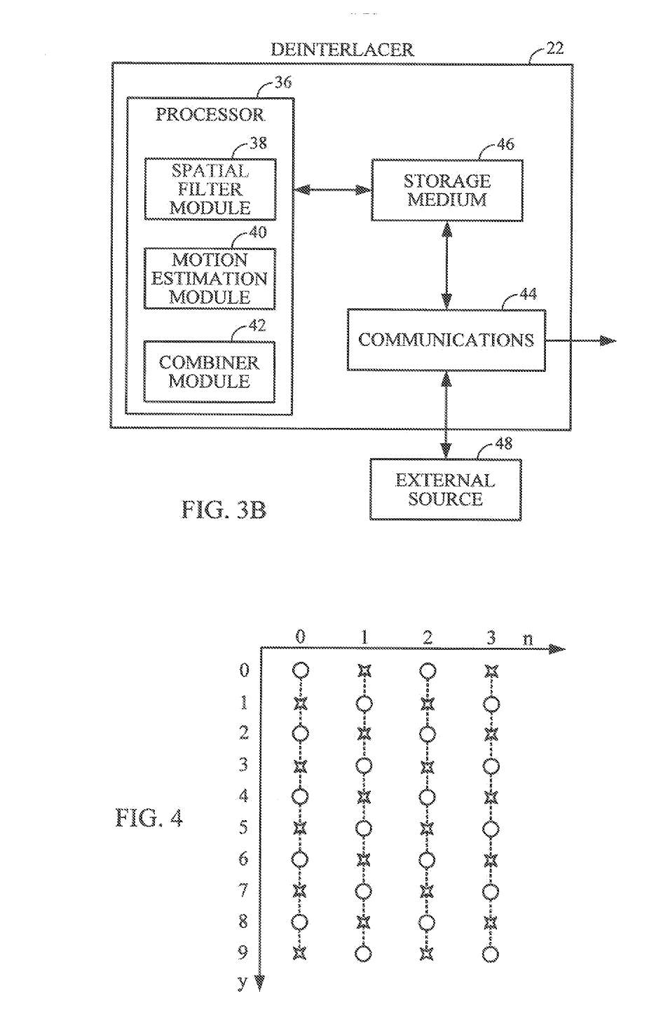

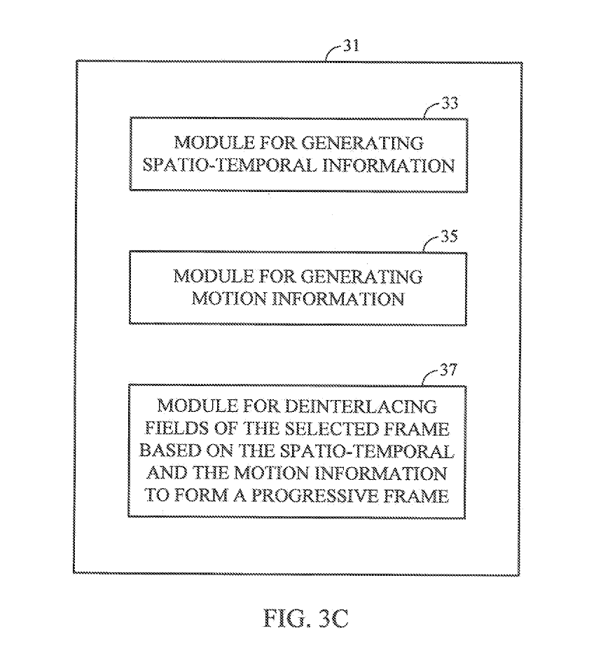

FIG. 3A is a block diagram illustrating one aspect of a deinterlacer 22. The deinterlacer 22 includes a spatial filter 30 that spatially and temporally (“spatio-temporal”) filters at least a portion of the interlaced data and generates spatio-temporal information. For example, Wmed can be used in the spatial filter 30. In some aspects the deinterlacer 22 also includes a denoising filter (not shown), for example, a Weiner filter or a wavelet shrinkage filter. The deinterlacer 22 also includes a motion estimator 32 which provides motion estimates and compensation of a selected frame of interlaced data and generates motion information. A combiner 34 in the deinterlacer 22 receives and combines the spatio-temporal information and the motion information to form a progressive frame.

FIG. 3B is another block diagram of the deinterlacer 22. A processor 36 in the deinterlacer 22 includes a spatial filter module 38, a motion estimator module 40, and a combiner module 42. Interlaced multimedia data from an external source 48 can be provided to a communications module 44 in the deinterlacer 22. The deinterlacer, and components or steps thereof, can be implemented by hardware, software, firmware, middleware, microcode, or any combination thereof. For example, a deinterlacer may be a standalone component, incorporated as hardware, firmware, middleware in a component of another device, or be implemented in microcode or software that is executed on the processor, or a combination thereof. When implemented in software, firmware, middleware or microcode, the program code or code segments that perform the deinterlacer tasks may be stored in a machine readable medium such as a storage medium. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents.

The received interlaced data can be stored in the deinterlacer 22 in a storage medium 46 which can include, for example, a chip configured storage medium (e.g., ROM, RAM) or a disc-type storage medium (e.g., magnetic or optical) connected to the processor 36. In some aspects, the processor 36 can contain part or all of the storage medium. The processor 36 is configured to process the interlaced multimedia data to form progressive frames which are then provided to another device or process.

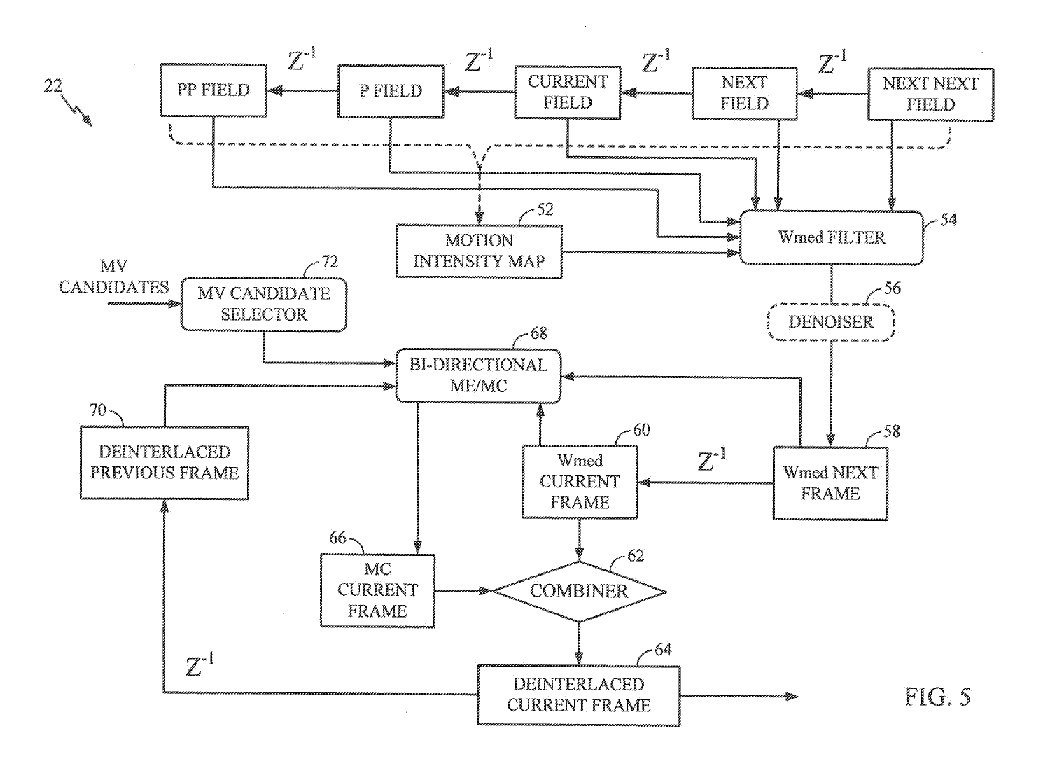

FIG. 3C is a block diagram illustrating another deinterlacing apparatus 31. The deinterlacing apparatus 31 includes means for generating spatio-temporal information such as a module for generating spatio-temporal information 33. The deinterlacing apparatus also includes means for generating motion information such as module for generating motion information 35. In some aspects the motion information is bi-directional motion information. The deinterlacing apparatus 31 also includes means for deinterlacing such as a module for deinterlacing fields of the selected frame 37, which produces a progressive frame associated with the a selected frame being processed based on the spatio-temporal and motion information. Processes that can be incorporated in the configuration of the modules illustrated in FIG. 3C are described throughout this application, including for example, in FIG. 5.

### Illustrative Aspect of A Spatio-Temporal Deinterlacer

As described above, traditional analog video devices like televisions render video in an interlaced manner, i.e., such devices transmit even-numbered scan lines (even field), and odd-numbered scan lines (odd field). From the signal sampling point of view, this is equivalent to a spatio-temporal subsampling in a pattern described by:

$$F ( x , y , n ) = \{ \begin{matrix}Θ ( x , y , n ) , & if y mod 2 = 0 for even fields , \\ Θ ( x , y , n ) , & if y mod 2 = 1 for odd fields , \\ Erasure , & otherwise ,\end{matrix} \qquad ( 1 )$$

where Θ stands for the original frame picture, F stands for the interlaced field, and (x, y, n) represents the horizontal, vertical, and temporal position of a pixel respectively.

Without loss of generality, it can be assumed n=0 is an even field throughout this disclosure so that Equation (1) above is simplified as

$$F ( x , y , n ) = \{ \begin{matrix}Θ ( x , y , n ) , & if y mod 2 = n mod 2 , \\ Erasure , & otherwise ,\end{matrix} \qquad ( 2 )$$

Since decimation is not conducted in the horizontal dimension, the sub-sampling pattern can be depicted in the next n˜y coordinate. In FIG. 4, both circles and stars represent positions where the original full-frame picture has a sample pixel. The interlacing process decimates the star pixels, while leaving the circle pixels intact. It should be noted that we index vertical positions starting from zero, therefore the even field is the top field, and the odd field is the bottom field.

The goal of a deinterlacer is to transform interlaced video (a sequence of fields) into non-interlaced progressive frames (a sequence of frames). In other words, interpolate even and odd fields to “recover” or generate full-frame pictures. This can be represented by Equation 3:

$${F}_{o} ( x , y , n ) = \{ \begin{matrix}F ( x , y , n ) , & y mod 2 = n mod 2 , \\ {F}_{i} ( x , y , n ) , & otherwise ,\end{matrix} \qquad ( 3 )$$

where Fᵢ represent deinterlacing results for missing pixels.

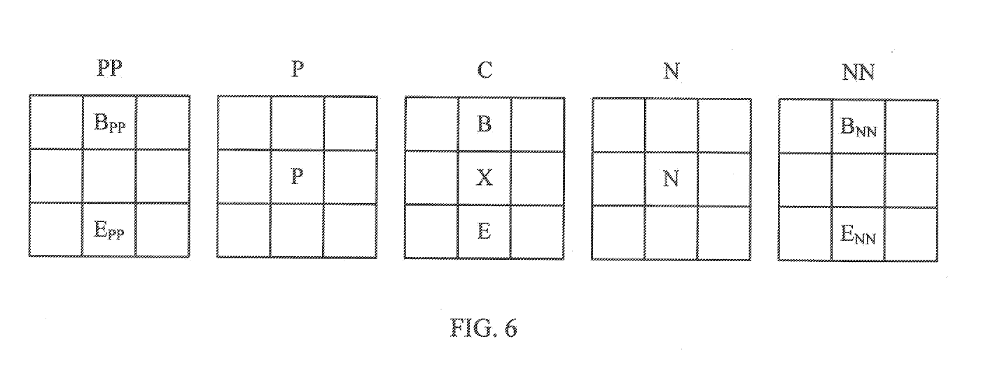

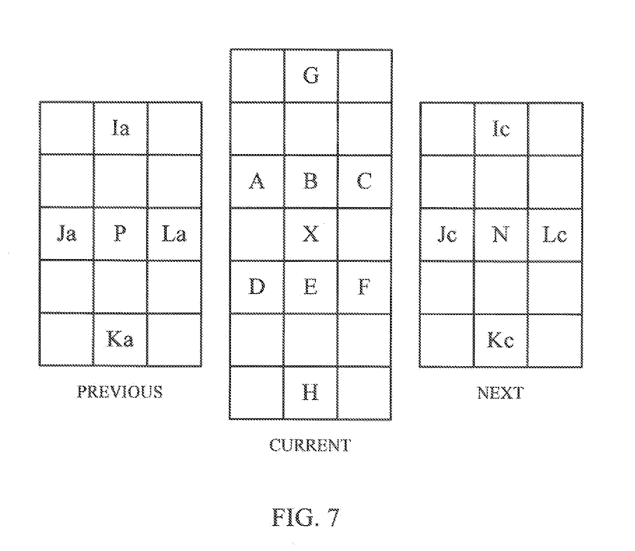

FIG. 5 is a block diagram illustrating certain aspects of an aspect of a deinterlacer 22 that uses Wmed filtering and motion estimation to generate a progressive frame from interlaced multimedia data. The upper part of FIG. 5 shows a motion intensity map 52 that can be generated using information from a current field, two previous fields (PP Field and P Field), and two subsequent fields (Next Field and Next Next field). The motion intensity map 52 categorizes, or partitions, the current frame into two or more different motion levels, and can be generated by spatio-temporal filtering, described in further detail hereinbelow. In some aspects, the motion intensity map 52 is generated to identify static areas, slow-motion areas, and fast-motion areas, as described in reference to Equations 4-8 below. A spatio-temporal filter, e.g., Wmed filter 54, filters the interlaced multimedia data using criteria based on the motion intensity map, and produces a spatio-temporal provisional deinterlaced frame. In some aspects, the Wmed filtering process involves a horizontal a neighborhood of [−1, 1], a vertical neighborhood of [−3, 3], and a temporal neighborhood of five adjacent fields, which are represented by the five fields (PP Field, P Field, Current Field, Next Field, Next Next Field) illustrated in FIG. 5, with Z⁻¹ representing a delay of one field. Relative to the Current Field, the Next Field and the P Field are non-parity fields and the PP Field and the Next Next Field are parity fields. The “neighborhood” used for spatio-temporal filtering refers to the spatial and temporal location of fields and pixels actually used during the filtering operation, and can be illustrated as an “aperture” as shown, for example, in FIGS. 6 and 7.

The deinterlacer 22 can also include a denoiser (denoising filter) 56. The denoiser 56 is configured to filter the spatio-temporal provisional deinterlaced frame generated by the Wmed filter 56. Denoising the spatio-temporal provisional deinterlaced frame makes the subsequent motion search process more accurate especially if the source interlaced multimedia data sequence is contaminated by white noise. It can also at least partly remove alias between even and odd rows in a Wmed picture. The denoiser 56 can be implemented as a variety of filters including a wavelet shrinkage and wavelet Wiener filter based denoiser which are also described further hereinbelow.

The bottom part of FIG. 5 illustrates an aspect for determining motion information (e.g., motion vector candidates, motion estimation, motion compensation) of interlaced multimedia data. In particular, FIG. 5 illustrates a motion estimation and motion compensation scheme that is used to generate a motion compensated provisional progressive frame of the selected frame, and then combined with the Wmed provisional frame to form a resulting “final” progressive frame, shown as deinterlaced current frame 64. In some aspects, motion vector (“MV”) candidates (or estimates) of the interlaced multimedia data are provided to the deinterlacer from external motion estimators and used to provide a starting point for bidirectional motion estimator and compensator (“ME/MC”) 68. In some aspects, a MV candidate selector 72 uses previously determined MV's for neighboring blocks for MV candidates of the blocks being processed, such as the MVs of previous processed blocks, for example blocks in a deinterlaced previous frame 70. The motion compensation can be done bidirectional, based on the previous deinterlaced frame 70 and a next (e.g., future) Wmed frame 58. A current Wmed frame 60 and a motion compensated (“MC”) current frame 66 are merged, or combined, by a combiner 62. A resulting deinterlaced current frame 64, now a progressive frame, is provided back to the ME/MC 68 to be used as a deinterlaced previous frame 70 and also communicated external to the deinterlacer for further processing, e.g., compression and transmission to a display terminal. The various aspects shown in FIG. 5 are described in more detail below.

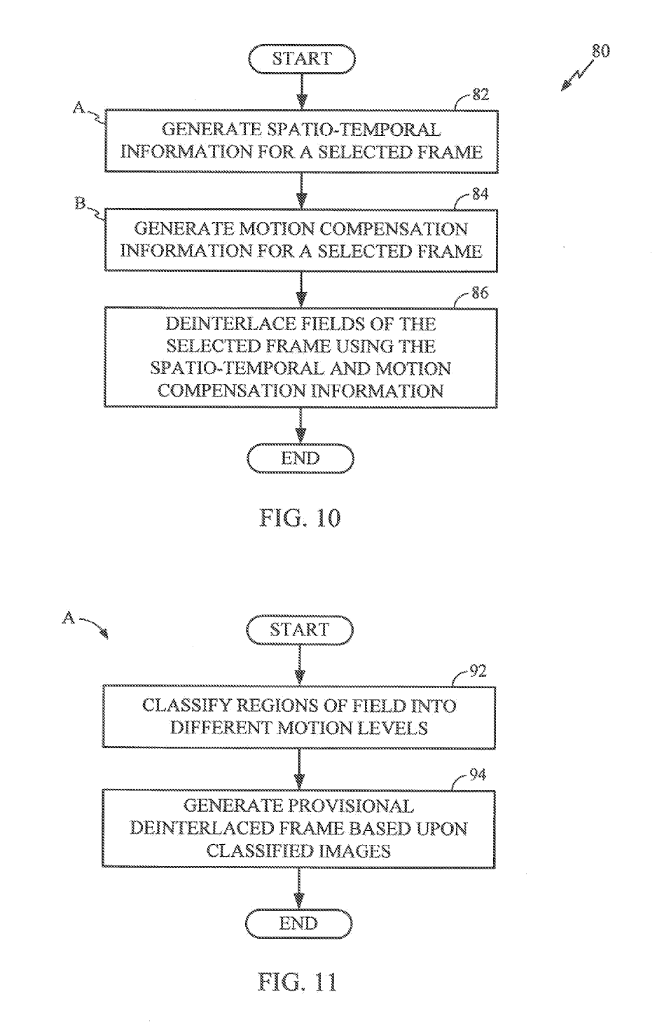

FIG. 10 illustrates a process 80 for processing multimedia data to produce a sequence of progressive frames from a sequence of interlaced frames. In one aspect, a progressive frame is produced by the deinterlacer illustrated in FIG. 5. At block 82, process 80 (process “A”) generates spatio-temporal information for a selected frame. Spatio-temporal information can include information used to categorize the motion levels of the multimedia data and generate a motion intensity map, and includes the Wmed provisional deinterlaced frame and information used to generate the frame (e.g., information used in Equations 4-11). This process can be performed by the Wmed filter 54, as illustrated in the upper portion of FIG. 5, and its associated processing, which is described in further detail below. In process A, illustrated in FIG. 11, regions are classified into fields of different motion levels at block 92, as further described below.

Next, at block 84 (process “B), process 80 generates motion compensation information for a selected frame. In one aspect, the bi-directional motion estimator/motion compensator 68, illustrated in the lower portion of FIG. 5, can perform this process. The process 80 then proceeds to block 86 where it deinterlaces fields of the selected frame based on the spatio-temporal information and the motion compensation information to form a progressive frame associated with the selected frame. This can be performed by the combiner 62 illustrated in the lower portion of FIG. 5.

### Motion Intensity Map

For each frame, a motion intensity 52 map can be determined by processing pixels in a current field to determine areas of different “motion.” An illustrative aspect of determining a three category motion intensity map is described below with reference to FIGS. 6-9. The motion intensity map designates areas of each frame as static areas, slow-motion areas, and fast motion areas based on comparing pixels in same-parity fields and different parity fields.

### Static Areas

Determining static areas of the motion map can comprise processing pixels in a neighborhood of adjacent fields to determine if luminance differences of certain pixel(s) meet certain criteria. In some aspects, determining static areas of the motion map comprises processing pixels in a neighborhood of five adjacent fields (a Current Field (C), two fields temporally before the current field, and two frames temporally after the Current Field) to determine if luminance differences of certain pixel(s) meet certain thresholds. These five fields are illustrated in FIG. 5 with Z⁻¹ representing a delay of one field. In other words, the five adjacent would typically be displayed in such a sequence with a Z⁻¹ time delay.

FIG. 6 illustrates an aperture identifying certain pixels of each of the five fields that can be used for the spatio-temporal filtering, according to some aspects. The aperture includes, from left to right, 3×3 pixel groups of a Previous Previous Field (PP), a Previous Field (P), the Current Field (C), a Next Field (N), and a Next Next Field (NN). In some aspects, an area of the Current Field is considered static in the motion map if it meets the criteria described in the Equations 4-6, the pixel locations and corresponding fields being illustrated in FIG. 6:

$$\begin{matrix}\vert {L}_{P} - {L}_{N} \vert < {T}_{1} \\ and & ( 4 ) \\ ( \vert \frac{{L}_{BPP} - {L}_{B}}{2} \vert + \vert \frac{{L}_{EPP} - {L}_{E}}{2} \vert < {T}_{1} ( forward static ) \\ or & ( 5 ) \\ \vert \frac{{L}_{BNN} - {L}_{B}}{2} \vert + \vert \frac{{L}_{ENN} - {L}_{E}}{2} \vert < {T}_{1} ( backward static ) ) , & ( 6 )\end{matrix}$$

where T₁ is a threshold,
Lp is the Luminance of a pixel P located in the P Field,
LN is the luminance of a pixel N located in the N Field,
LB is the Luminance of a pixel B located in the Current Field,
LE is the Luminance of a pixel E located in the Current Field,
LBPP is the Luminance of a pixel Bpp located in the PP Field,
LEPP is the Luminance of a pixel Epp located in the PP Field,
LBNN is the luminance of a pixel BNN located in the NN Field, and
LENN is the Luminance of a pixel ENN located in the NN Field.

Threshold T₁ can be predetermined and set at a particular value, determined by a process other than deinterlacing and provided (for example, as metadata for the video being deinterlaced) or it can be dynamically determined during deinterlacing.

The static area criteria described above in Equation 4, 5, and 6 use more fields than conventional deinterlacing techniques for at least two reasons. First, comparison between same-parity fields has lower alias and phase-mismatch than comparison between different-parity fields. However, the least temporal difference (hence correlation) between the field being processed and its most adjacent same-parity field neighbors is two fields, larger than that from its different-parity field neighbors. A combination of more reliable different-parity fields and lower-alias same-parity fields can improve the accuracy of the static area detection.

In addition, the five fields can be distributed symmetrically in the past and in the future relative to a pixel X in the Current Frame C, as shown in FIG. 6. The static area can be sub-divided into three categories: forward static (static relative to the previous frame), backward static (static relative to the next frame), or bidirectional (if both the forward and the backward criteria are satisfied). This finer categorization of the static areas can improve performance especially at scene changes and object appearing/disappearing.

### Slow-Motion Areas

An area of the motion-map can be considered a slow-motions area in the motion-map if the luminance values of certain pixels do not meet the criteria appropriate for designating a static area but meet criteria appropriate for designating a slow-motion area. Equation 7 below defines criteria that can be used to determine a slow-motion area. Referring to FIG. 7, the locations of pixels Ia, Ic, Ja, Jc, Ka, Kc, La, Lc, P and N identified in Equation 7 are shown in an aperture centered around pixel X. The aperture includes a 3×7 pixel neighborhood of the Current Field (C) and 3×5 neighborhoods of the Next Field (N) a Previous Field (P). Pixel X is considered to be part of a slow-motion area if it does not meet the above-listed criteria for a static area and if pixels in the aperture meet the following criteria shown in Equation 7:
(|L_{Ia}−L_{Ic}|+|L_{Ja}−L_{Jc}|+|L_{Ja}−L_{Jc}|+|L_{Ka}−L_{Kc}|+|L_{La}−L_{Lc}|+|L_{P}−L_{N}|)/5<T₂ (7)
where T₂ is a threshold, and
L_{Ia}, L_{Ic}, L_{Ja}, L_{Jc}, L_{Ja}, L_{Jc}, L_{Ka}, L_{Kc}, L_{La}, L_{Lc}, L_{P}, L_{N} are luminance values for pixels Ia, Ic, Ja, Jc, Ka, Kc, La, Lc, P and N, respectively.

The threshold T₂ can also be predetermined and set at a particular value, determined by a process other than deinterlacing and provided (for example, as metadata for the video being deinterlaced) or it can be dynamically determined during deinterlacing.

It should be noted that a filter can blur edges that are horizontal (e.g., more than 45° from vertically aligned) because of the angle of its edge detection capability. For example, the edge detection capability of the aperture (filter) illustrated in FIG. 7 is affected by the angle formed by pixel “A” and “F”, or “C” and “D”. Any edges more horizontal than such an angle that will not be interpolated optimally and hence staircase artifacts may appear at those edges. In some aspects, the slow-motion category can be divided into two sub-categories, “Horizontal Edge” and “otherwise” to account for this edge detection effect. The slow-motion pixel can be categorized as a Horizontal Edge if the criteria in Equation 8, shown below, is satisfied, and to a so-called “Otherwise” category if the criteria is not satisfied.
|(LA+LB+LC)−(LD+LE+LF)|<T₃ (8)
where T₃ is a threshold value, and LA, LB, LC, LD, LE, and LF are the luminance values of pixels A, B, C, D, E, and F.

Different interpolation methods can used for each of the Horizontal Edge and the Otherwise category.

### Fast-Motion Areas

If the criteria for a static area and the criteria for the slow-motion area are not met, the pixel can be deemed to be in a fast-motion area.

Having categorized the pixels in a selected frame, process A (FIG. 11) then proceeds to block 94 and generates a provisional deinterlaced frame based upon the motion intensity map. In this aspect, Wmed filter 54 (FIG. 5) filters the selected field and the appropriate adjacent fields(s) to provide a candidate full-frame image F₀ which can be defined as follows:

$${F}_{o} ( \vec{x} , n ) = \{ \begin{matrix}F ( \vec{x} , n ) , & ( y mod 2 = n mod 2 ) \\ \frac{1}{2} ( F ( \vec{x} , n - 1 ) + F ( \vec{x} , n + 1 ) ) , & ( static backward and forward ) \\ F ( \vec{x} , n - 1 ) & ( static forward but not forward ) \\ F ( \vec{x} , n + 1 ) & ( static backward but not forward ) \\ med ( A , B , C , D , E , F ) , & ( slow motion w \text{/} o horizontal edge ) \\ med ( {α}_{0} \frac{A + F}{2} , {α}_{1} \frac{B + E}{2} , {α}_{2} \frac{C + D}{2} , {α}_{3} \frac{G + H}{2} ) , & ( slow motion w \text{/} horizontal edge ) \\ \frac{B + E}{2} , & ( fast motion )\end{matrix} \qquad ( 9 )$$

where αᵢ (i=0, 1, 2, 3) are integer weights calculated as below:

$$\begin{matrix}{α}_{i} = \{ \begin{matrix}2 & if {β}_{i} = min \{ {β}_{0} , {β}_{1} , {β}_{2} , {β}_{3} \} \\ 1 , & otherwise\end{matrix} , & ( 10 ) \\ {β}_{0} = \frac{A + F}{\vert A - F \vert} , {β}_{1} = \frac{B + E}{\vert B - E \vert} , {β}_{2} = \frac{C + D}{\vert C - D \vert} , {β}_{3} = \frac{G + H}{\vert G - H \vert} . & ( 11 )\end{matrix}$$

The Wmed filtered provisional deinterlaced frame is provided for further processing in conjunction with motion estimation and motion compensation processing, as illustrated in the lower portion of FIG. 5.

As described above and shown in Equation 9, the static interpolation comprises inter-field interpolation and the slow-motion and fast-motion interpolation comprises intra-field interpolation. In certain aspects where temporal (e.g., inter-field) interpolation of same parity fields is not desired, temporal interpolation can be “disabled” by setting the threshold T₁ (Equations 4-6) to zero (T₁=0). Processing of the current field with temporal interpolation disabled results in categorizing no areas of the motion-level map as static, and the Wmed filter 54 (FIG. 5) may need the three fields illustrated in the aperture in FIG. 7 which operate on a current field and the two adjacent non-parity fields.

### Denoising

In certain aspects, a denoiser can be used to remove noise from the candidate Wmed frame before it is further processed using motion compensation information. A denoiser can remove noise that is present in the Wmed frame and retain the signal present regardless of the signal's frequency content. Various types of denoising filters can be used, including wavelet filters. Wavelets are a class of functions used to localize a given signal in both space and scaling domains. The fundamental idea behind wavelets is to analyze the signal at different scales or resolutions such that small changes in the wavelet representation produce a correspondingly small change in the original signal.

In some aspects, a denoising filter is based on an aspect of a (4, 2) bi-orthogonal cubic B-spline wavelet filter. One such filter can be defined by the following forward and inverse transforms:

$$\begin{matrix}h ( z ) = \frac{3}{4} + \frac{1}{2} ( z + {z}^{- 1} ) + \frac{1}{8} ( z + {z}^{- 2} ) ( forward transform ) \\ and & ( 12 ) \\ g ( z ) = \frac{5}{4} {z}^{- 1} - \frac{5}{32} ( 1 + {z}^{- 2} ) - \frac{3}{8} ( z + {z}^{- 3} ) - \frac{3}{32} ( {z}^{2} + {z}^{- 4} ) ( inverse transform ) & ( 13 )\end{matrix}$$

Application of a denoising filter can increase the accuracy of motion compensation in a noisy environment. Noise in the video sequence is assumed to be additive white Gaussian. The estimated variance of the noise is denoted by \hat{σ}. It can be estimated as the median absolute deviation of the highest-frequency subband coefficients divided by 0.6745. Implementations of such filters are described further in “Ideal spatial adaptation by wavelet shrinkage,” D. L. Donoho and I. M. Johnstone, Biometrika, vol. 8, pp. 425-455, 1994, which is incorporated by reference herein in its entirety.

A wavelet shrinkage or a wavelet Wiener filter can be also be applied as the denoiser. Wavelet shrinkage denoising can involve shrinking in the wavelet transform domain, and typically comprises three steps: a linear forward wavelet transform, a nonlinear shrinkage denoising, and a linear inverse wavelet transform. The Wiener filter is a MSE-optimal linear filter which can be used to improve images degraded by additive noise and blurring. Such filters are generally known in the art and are described, for example, in “Ideal spatial adaptation by wavelet shrinkage,” referenced above, and by S. P. Ghael, A. M. Sayeed, and R. G. Baraniuk, “Improvement Wavelet denoising via empirical Wiener filtering,” Proceedings of SPIE, vol. 3169, pp. 389-399, San Diego, July 1997.

### Motion Compensation

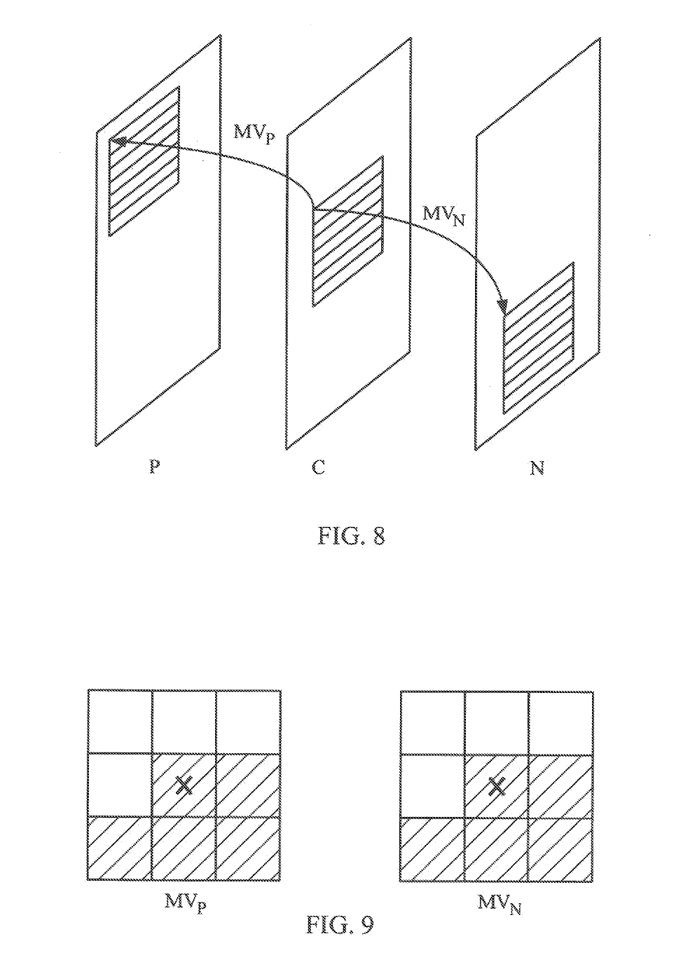

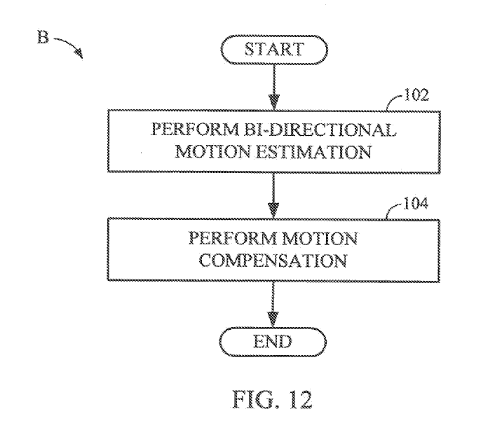

Referring to FIG. 12, at block 102 process B performs bidirectional motion estimation, and then at block 104 uses motion estimates to perform motion compensation, which is illustrated further illustrated in FIG. 5, and described in an illustrative aspect hereinbelow. There is a one field “lag” between the Wmed filter and the motion-compensation based deinterlacer. Motion compensation information for the “missing” data (the non-original rows of pixel data) of the Current Field “C” is being predicted from information in both the previous frame “P” and the next frame “N” as shown in FIG. 8. In the Current Field (FIG. 6) solid lines represent rows where original pixel data exist and dashed lines represent rows where Wmed-interpolated pixel data exist. In certain aspects, motion compensation is performed in a 4-row by 8-column pixel neighborhood. However, this pixel neighborhood is an example for purposes of explanation, and it will be apparent to those skilled in the art that motion compensation may be performed in other aspects based on a pixel neighborhood comprising a different number rows and a different number of columns, the choice of which can be based on many factors including, for example, computational speed, available processing power, or characteristics of the multimedia data being deinterlaced. Because the Current Field only has half of the rows, the four rows to be matched actually correspond to an 8-pixel by 8-pixel area.

Referring to FIG. 5, the bi-directional ME/MC 68 can use sum of squared errors (SSE) can be used to measure the similarity between a predicting block and a predicted block for the Wmed current frame 60 relative to the Wmed next frame 58 and the deinterlaced current frame 70. The generation of the motion compensated current frame 66 then uses pixel information from the most similar matching blocks to fill in the missing data between the original pixel lines. In some aspects, the bidirectional ME/MC 68 biases or gives more weight to the pixel information from the deinterlaced previous frame 70 information because it was generated by motion compensation information and Wmed information, while the Wmed next frame 58 is only deinterlaced by spatio-temporal filtering.

In some aspects, to improve matching performance in regions of fields that have similar-luma regions but different-chroma regions, an SSE metric can be used that includes the contribution of pixel values of one or more luma group of pixels (e.g., one 4-row by 8-column luma block) and one or more chroma group of pixels (e.g., two 2-row by 4-column chroma blocks U and V). Such approaches effectively reduces mismatch at color sensitive regions.

Motion Vectors (MVs) have granularity of ½ pixels in the vertical dimension, and either ½ or ¼ pixels in the horizontal dimension. To obtain fractional-pixel samples, interpolation filters can be used. For example, some filters that can be used to obtain half-pixel samples include a bilinear filter (1, 1), an interpolation filter recommended by H.263/AVC: (1, −5, 20, 20, −5, 1), and a six-tap Hamming windowed ???sinc??? function filter (3, −21, 147, 147, −21, 3). ¼-pixel samples can be generated from full and half pixel sample by applying a bilinear filter.

In some aspects, motion compensation can use various types of searching processes to match data (e.g., depicting an object) at a certain location of a current frame to corresponding data at a different location in another frame (e.g., a next frame or a previous frame), the difference in location within the respective frames indicating the object's motion. For example, the searching processes use a full motion search which may cover a larger search area or a fast motion search which can use fewer pixels, and/or the selected pixels used in the search pattern can have a particular shape, e.g., a diamond shape. For fast motion searches, the search areas can be centered around motion estimates, or motion candidates, which can be used as a starting point for searching the adjacent frames. In some aspects, MV candidates can be generated from external motion estimators and provided to the deinterlacer. Motion vectors of a macroblock from a corresponding neighborhood in a previously motion compensated adjacent frame can also be used as a motion estimate. In some aspects, MV candidates can be generated from searching a neighborhood of macroblocks (e.g., a 3-macroblock by 3-macroblock) of the corresponding previous and next frames.

FIG. 9 illustrates an example of two MV maps, MV_{P} and MV_{N}, that could be generated during motion estimation/compensation by searching a neighborhood of the previous frame and the next frame, as show in FIG. 8. In both MV_{P} and MV_{N} the block to be processed to determine motion information is the center block denoted by “X.” In both MV_{P} and MV_{N}, there are nine MV candidates that can be used during motion estimation of the current block X being processed. In this example, four of the MV candidates exist in the same field from earlier performed motion searches and are depicted by the lighter-colored blocks in MV_{P} and MV_{N} (FIG. 9). Five other MV candidates, depicted by the darker-colored blocks, were copied from the motion information (or maps) of the previously processed frame.

After motion estimation/compensation is completed, two interpolation results may result for the missing rows (denoted by the dashed lines in FIG. 8): one interpolation result generated by the Wmed filter (Wmed Current Frame 60 FIG. 5) and one interpolation result generated by motion estimation processing of the motion compensator (MC Current Frame 66). A combiner 62 typically merges the Wmed Current Frame 60 and the MC Current Frame 66 by using at least a portion of the Wmed Current Frame 60 and the MC Current Frame 66 to generate a Current Deinterlaced Frame 64. However, under certain conditions, the combiner 62 may generate a Current Deinterlaced frame using only one of the Current Frame 60 or the MC Current Frame 66. In one example, the combiner 62 merges the Wmed Current Frame 60 and the MC Current Frame 66 to generate a deinterlaced output signal as shown in Equation 14:

$${F}_{o} ( \vec{x} , n ) = \{ \begin{matrix}F ( \vec{x} , n ) , & ( y mod 2 = n mod 2 ) \\ {k}_{2} {F}_{Wmed} ( \vec{x} , n ) + ( 1 - {k}_{2} {F}_{MC} ( \vec{x} - \vec{D} , n - 1 ) ) , & otherwise\end{matrix} . \qquad ( 14 )$$

where F(\vec{x},n) is used for the luminance value in field nᵢ at position x=(x, y)^{t} with ^{t} for transpose. Using a clip function defined as
clip(0, 1, a)=0, if (a<0); 1, if (a>1); a, otherwise (15)
k₁ can be calculated as:
k₁=clip(0, C₁\sqrt{Diff}) (16)
where C₁ is a robustness parameter, and Diff is the luma difference between the predicting frame pixel and the available pixel in the predicted frame (taken from the existing field). By appropriately choosing C1, it is possible to tune the relative importance of the mean square error. k₂ can be calculated as shown in Equation 17:

$${k}_{2} = 1 - clip ( 0 , 1 , ( 1 - {k}_{1} ) \frac{\vert {F}_{Wmed} ( \vec{x} - {\vec{y}}_{u} , n ) - {F}_{MC} ( \vec{x} - {\vec{y}}_{u} - \vec{D} , n - 1 ) \vert + δ}{\vert {F}_{Wmed} ( \vec{x} , n ) - {F}_{MC} ( \vec{x} - \vec{D} , n - 1 ) \vert + δ} ) \qquad ( 17 )$$

where \vec{x}=(x,y), \vec{y}ᵤ=(0,1), \vec{D} is the motion vector, δ is a small constant to prevent division by zero. Deinterlacing using clipping functions for filtering is further described in “De-interlacing of video data,” G. D. Haan and E. B. Bellers, IEEE Transactions on Consumer Electronics, Vol. 43, No. 3, pp. 819-825, 1997, which is incorporated herein in its entirety.

In some aspects, the combiner 62 can be configured to try and maintain the following equation to achieve a high PSNR and robust results:
|F₀(\vec{x},n)−−F_{Wmed}(\vec{x},n)|=|F₀(\vec{x}−\vec{y}ᵤ,n)−F_{Wmed}(\vec{x}−\vec{y}ᵤ,n)| (17)

It is possible to decouple deinterlacing prediction schemes comprising inter-field interpolation from intra-field interpolation with a Wmed+MC deinterlacing scheme. In other words, the spatio-temporal Wmed filtering can be used mainly for intra-field interpolation purposes, while inter-field interpolation can be performed during motion compensation. This reduces the peak signal-to-noise ratio of the Wmed result, but the visual quality after motion compensation is applied is more pleasing, because bad pixels from inaccurate inter-field prediction mode decisions will be removed from the Wmed filtering process.

Chroma handling may need to be consistent with the collocated luma handling. In terms of motion map generation, the motion level of a chroma pixel is obtained by observing the motion level of its four collocated luma pixels. The operation can be based on voting (chroma motion level borrows the dominant luma motion level). However, we propose to use a conservative approach as follows. If any one of the four luma pixels has a fast motion level, the chroma motion level shall be fast-motion; other wise, if any one of the four luma pixels has a slow motion level, the chroma motion level shall be slow-motion; otherwise the chroma motion level is static. The conservative approach may not achieve the highest PSNR, but it avoids the risk of using INTER prediction wherever there is ambiguity in chroma motion level.

Multimedia data sequences were deinterlaced using the described Wmed algorithm described alone and the combined Wmed and motion compensated algorithm described herein. The same multimedia data sequences were also deinterlaced using a pixel blending (or averaging) algorithm and a “no-deinterlacing” case where the fields were merely combined without any interpolation or blending. The resulting frames were analyzed to determine the PSNR and is shown in the following table:

| PSNR | | | | |
|---|---|---|---|---|
| (dB) | no | | | Wmed + |
| sequence | deinterlacing | blending | Wmed | MC |
| soccer | 8.955194 | 11.38215 | 19.26221 | 19.50528 |
| city | 11.64183 | 12.93981 | 15.03303 | 15.09859 |
| crew | 13.32435 | 15.66387 | 22.36501 | 22.58777 |

Even though there is only marginal PSNR improvement by deinterlacing using the MC in addition to Wmed, the visual quality of the deinterlaced image produced by combining the Wmed and MC interpolation results is more visually pleasing to because as mentioned above, combining the Wmed results and the MC results suppresses alias and noise between even and odd fields.

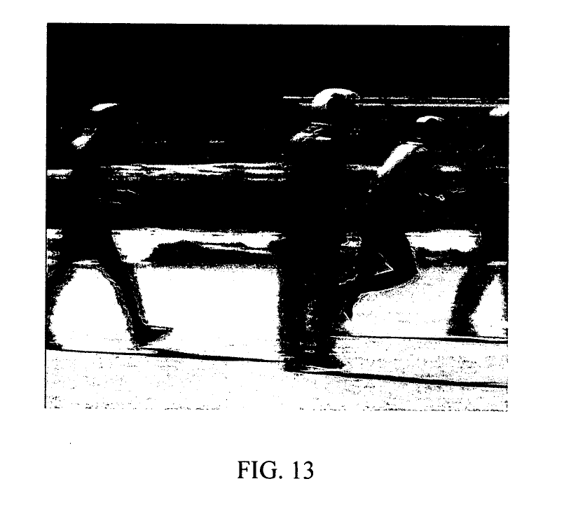

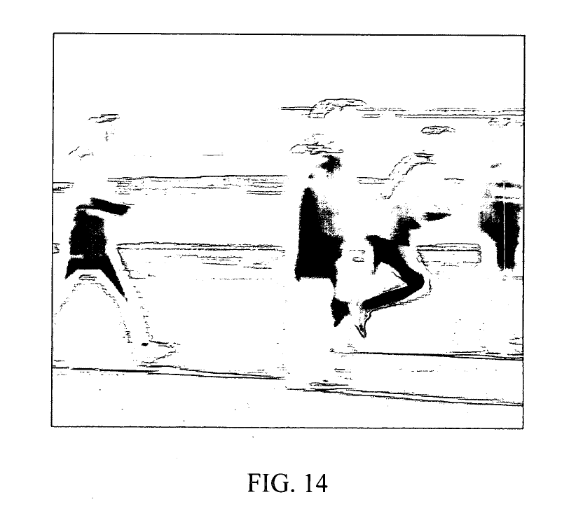

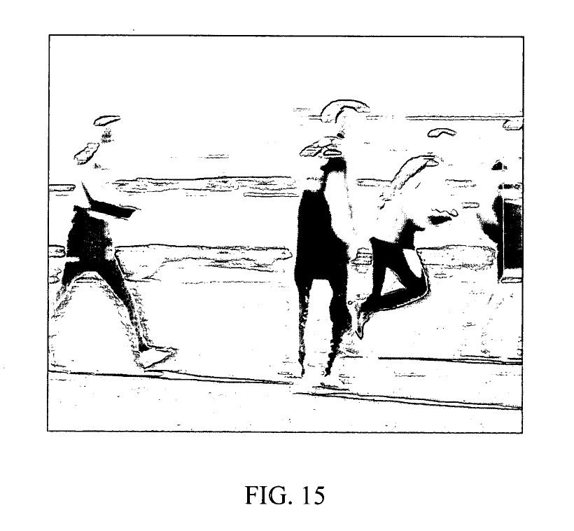

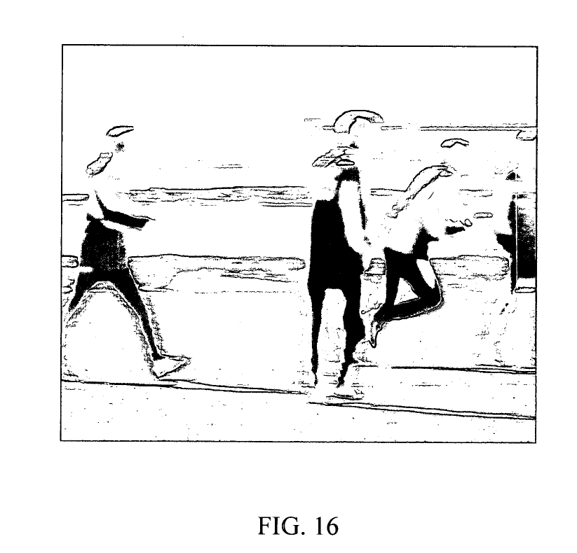

FIGS. 13-15 illustrate an example of the performance of the described deinterlacers. FIG. 13 shows an original frame #109 of “soccer.” FIG. 14 shows the same frame #109 as interlaced data. FIG. 15 shows frame #109 as a Wmed frame, in other words, the resulting Wmed frame after being processed by the Wmed filter 54 (FIG. 5). FIG. 16 shows frame #109 resulting from the combination of the Wmed interpolation and the motion compensation interpolation.

It is noted that the aspects may be described as a process which is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

It should also be apparent to those skilled in the art that one or more elements of a device disclosed herein may be rearranged without affecting the operation of the device. Similarly, one or more elements of a device disclosed herein may be combined without affecting the operation of the device. Those of ordinary skill in the art would understand that information and signals may be represented using any of a variety of different technologies and techniques. Those of ordinary skill would further appreciate that the various illustrative logical blocks, modules, and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed methods.

The steps of a method or algorithm described in connection with the examples disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

In addition, the various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples and additional elements may be added without departing from the spirit or scope of the disclosed method and apparatus. The description of the aspects is intended to be illustrative, and not to limit the scope of the claims.

What is claimed is:

1. A method of processing multimedia data, the method comprising:
generating spatio-temporal information for a selected frame of interlaced multimedia data;
generating motion compensation information for the selected frame; and
deinterlacing fields of the selected frame based on the spatio-temporal information and the motion compensation information to form a progressive frame associated with the selected frame.

2. The method of claim 1, wherein generating spatio-temporal information comprises generating a spatio-temporal provisional deinterlaced frame, wherein generating motion information comprises generating a motion compensated provisional deinterlaced frame, and wherein deinterlacing fields of the selected frame further comprises combining said spatio-temporal provisional deinterlaced frame and said motion compensated provisional deinterlaced frame to form the progressive frame.

3. The method of claim 1, further comprising using motion vector candidates to generate said motion compensation information.

4. The method of claim 1, further comprising
receiving motion vector candidates;
determining motion vectors based on said motion vector candidates; and
using said motion vectors to generate the motion compensation information.

5. The method of claim 1, further comprising
determining a motion vector candidate for a block of video data in the selected frame from motion vector estimates of its neighboring blocks; and
using said motion vector candidates to generate the motion compensation information.

6. The method of claim 1, wherein generating spatio-temporal information comprises:
generating at least one motion intensity map; and
generating a provisional deinterlaced frame based on the motion intensity map, wherein said deinterlacing comprises using the provisional deinterlaced frame and the motion information to generate the progressive frame.

7. The method of claim 6, wherein generating a provisional deinterlaced frame comprises spatial filtering the interlaced multimedia data if the at least one motion intensity map indicates a selected condition.

8. The method of claim 6, wherein generating at least one motion intensity map comprises classifying regions of the selected frame into different motion levels.

9. The method of claim 8, wherein generating at least one motion intensity map comprises spatial filtering the interlaced multimedia data based on the different motion levels.

10. The method of claim 1, wherein spatial filtering comprises processing the interlaced multimedia data using a weighted median filter.

11. The method of claim 6, wherein generating a provisional deinterlaced frame comprises spatial filtering across multiple fields of the interlaced multimedia data based on the motion intensity map.

12. The method of claim 1, wherein generating spatio-temporal information comprises spatio-temporal filtering across a temporal neighborhood of fields of a selected current field.

13. The method of claim 12, wherein the temporal neighborhood comprises a previous field that is temporally located previous to the current field, and comprises a next field that is temporally located subsequent to the current field.

14. The method of claim 12, wherein the temporal neighborhood comprises a plurality of previous fields that are temporally located previous to the current field, and comprises a plurality of next fields that are temporally located subsequent to the current field.

15. The method of claim 1, wherein generating spatio-temporal information comprises generating a provisional deinterlaced frame based on spatio-temporal filtering and filtering said provisional deinterlaced frame using a denoising filter.

16. The method of claim 15, wherein deinterlacing fields of the selected frame comprises combining the denoised provisional deinterlaced frame with motion information to form said progressive frame.

17. The method of claim 15, wherein said denoising filter comprises a wavelet shrinkage filter.

18. The method of claim 15, wherein said denoising filter comprises a Weiner filter.

19. The method of claim 1, wherein generating motion information comprises performing bi-directional motion estimation on the selected field to generate motion vectors, and performing motion compensation using the motion vectors.

20. The method of claim 1, further comprising:
generating a provisional deinterlaced frame associated with the selected frame based on the spatio-temporal information;
obtaining motion vectors on the provisional deinterlaced frame; and
performing motion compensation using the motion vectors to generate the motion information, wherein the motion information comprises a motion compensated frame, and
wherein deinterlacing comprises combining the motion compensated frame and the provisional deinterlaced frame.

21. The method of claim 20, further comprising:
generating a sequence of provisional deinterlaced frames in a temporal neighborhood around the selected frame based on the spatio-temporal information; and
generating motion vectors using the sequence of provisional deinterlaced frames.

22. The method of claim 20, wherein performing motion compensation comprises performing bidirectional motion compensation.

23. The method of claim 21, further comprising denoising filtering the provisional deinterlaced frame.

24. The method of claim 21, wherein the sequence of provisional interlaced frames comprises a provisional deinterlaced frame of the multimedia data previous to the provisional deinterlaced frame of the selected frame and a provisional deinterlaced frame of the multimedia data subsequent to the provisional deinterlaced frame of the selected frame.

25. An apparatus for processing multimedia data, comprising:
a filter module configured to generate spatio-temporal information of a selected frame of interlaced multimedia data;
a motion estimator configured to generate bidirectional motion information for the selected frame; and
a combiner configured to form a progressive frame associated with the selected frame using the spatio-temporal information and the motion information.

26. The apparatus of claim 25, further comprising a denoiser configured to remove noise from the spatio-temporal information.

27. The apparatus of claim 25, wherein said spatio-temporal information comprises a spatio-temporal provisional deinterlaced frame, wherein said motion information comprises a motion compensated provisional deinterlaced frame, and wherein said combiner is further configured to form the progressive frame by combining said spatio-temporal provisional deinterlaced frame and said motion compensated provisional deinterlaced frame

28. The apparatus of claim 25, wherein the motion information is bi-directional motion information.

29. The apparatus of claim 26, wherein said filter module is further configured to determine a motion intensity map of the selected frame and use the motion intensity map to generate a spatio-temporal provisional deinterlaced frame, and said combiner is configured to form the progressive frame by combining the motion information with the spatio-temporal provisional deinterlaced frame.

30. The apparatus of claim 24, wherein the motion estimator is configured to use a previously generated progressive frame to generate at least a portion of the motion information.

31. An apparatus for processing multimedia data comprising:
means for generating spatio-temporal information for a selected frame of interlaced multimedia data;
means for generating motion information for the selected frame; and
means for deinterlacing fields of the selected frame based on the spatio-temporal information and the motion information to form a progressive frame associated with the selected frame.

32. The apparatus of claim 31, wherein the spatio-temporal information comprises a spatio-temporal provisional deinterlaced frame, wherein the motion information comprises a motion compensated provisional deinterlaced frame, and wherein said deinterlacing means comprises means for combining the spatio-temporal provisional deinterlaced frame and the motion compensated provisional deinterlaced frame to form the progressive frame.

33. The apparatus of claim 31, wherein the deinterlacing means comprise a combiner configured to form the progressive frame by combining spatial temporal information and motion information.

34. The apparatus of claim 31, wherein the motion information comprises bi-directional motion information.

35. The apparatus of claim 32, wherein the generating spatio-temporal information means is configured to generate a motion intensity map of the selected frame and to use the motion intensity map to generate a spatio-temporal provisional deinterlaced frame, and wherein said combining means is configured to form the progressive frame by combining the motion information with the spatio-temporal provisional deinterlaced frame.

36. The apparatus of claim 31, wherein the generating spatio-temporal information means is configured to:
generate at least one motion intensity map; and
generate a provisional deinterlaced frame based on the motion intensity map,
wherein the deinterlacing means is configured to generate the progressive frame using the provisional deinterlaced frame and the motion information

37. The apparatus of claim 36, wherein generating a provisional deinterlaced frame comprises spatial filtering the interlaced multimedia data if the at least one motion intensity map indicates a selected condition.

38. The apparatus of claim 36, wherein generating at least one motion intensity map comprises classifying regions of the selected frame into different motion levels.

39. The apparatus of claim 38, wherein generating at least one motion intensity map comprises spatial filtering the interlaced multimedia data based on the different motion levels.

40. A machine readable medium comprising instructions for processing multimedia data, wherein the instructions upon execution cause a machine to:
generate spatio-temporal information for a selected frame of interlaced multimedia data;
generate bi-directional motion information for the selected frame; and
deinterlace fields of the frame based on the spatio-temporal information and the motion information to form a progressive frame corresponding to the selected frame.

41. A processor for processing multimedia data, said processor being configured to:
generate spatio-temporal information of a selected frame of interlaced multimedia data;
generate motion information for the selected frame; and
deinterlace fields of the selected frame to form a progressive frame associated with the selected frame based on the spatio-temporal information and the motion information.
